(19) United States
(12) Patent Application Publication
(10) Pub. No.: US 2002/0033846 A1
(43) Pub. Date: Mar. 21, 2002

(54) Apparatus for controlling the display of and for resolving special characters in URLs, URIs & email addresses and mehtod therefor

(76) Inventors: Ramakrishnan Balasubramanian, Chennai (IN); Ramesh Babu Kandaswamy, Chennai (IN)

Correspondence Address: RAMAKRISHNAN BALASUBRAMANIAN, 24/16 Dr. SUBBARAYA NAGAR IV STREET, KODAMBAKKAM, CHENNAI, 600024, IN

(21) Appl. No.: 09/946,667

(22) Filed: Sep. 6, 2001

Related U.S. Application Data
(60) Provisional application No. 60/235,735, filed on Sep. 14, 2000.

(51) Int. Cl. G06F 3/00

(52) U.S. Cl. 345/764

(57) ABSTRACT

A method and apparatus for controlling the display of and for resolving special characters in URL's URI's and Email ID's is implemented. In response to the entry of an URL during a browsing session, the web browser retrieves the URL and displays on the address bar a message read from a server. This message can be in addition to or in lieu of the URL. This allows the display of meaningful information on the address bar of a Web browser, that otherwise displays a URL that is usually cryptic. Also, in response to an entry of a URL/URI/Email ID with non-permitted special characters (such as space), the web browser converts them into a standard format by removal of the non-permitted special characters and fetches the appropriate file.

### TECHNICAL FIELD

The present invention relates in general to data processing systems, and in particular, to web browser methodologies in data processing systems.

### BACKGROUND OF THE INVENTION

1. Field of the Invention

This invention relates generally to the field of Computers and Software, and more particularly to the display of web pages and URLs in a Web browser that accesses information from the World Wide Web and other Networks

2. Description of Related Art

As known in the art, the Internet is a worldwide collection of networks and gateways that use the TCP/IP suite of protocols to communicate with one another. At the heart of the Internet is a backbone of high speed data communication lines between major nodes or host computers consisting of thousands of commercial government educational and other computer systems that route data and messages.

The World Wide Web (WWW) refers to the total set of interlinked hypertext documents residing on hypertext transfer protocol (HTTP) servers all around the world. Documents on the WWW, called pages or web pages, are written in hypertext mark-up language (HTML) identified by uniform resource locators (URL) that specify the particular machine and pathname by which a file can be accessed and transmitted from node to node to the end user under HTTP. A web site is a related group of these documents and associated files, scripts, sub procedures, and databases that are served up by an HTTP server on the WWW.

Users need a browser program and an Internet connection to access a web site. Browser programs, also called “web browsers,” are client applications that enable a user to navigate the Internet and view HTML documents on the WWW, another network, or the user's computer. The most exciting development in Internet is the release of a Web “browser” called Mosaic in 1993. It had a simple but powerful graphic interface. The browser allows a user to retrieve web documents and navigate the Web using simple commands and popular tools and methods such as point-and-click. Because the user does not have to be technically trained and the browser is pleasant to use, it resulted in the opening up of Internet to the masses.

A document designed to be accessed and read over the web is called a web page. Each web page must have an address in a recognized format—the URL, or Uniform Resource Locator—that enables computers all over the world to access it. Each web page has a unique URL/URI. The URLs or URIs are generally keyed into the browser's address bar. These call up the appropriate pages from appropriate servers and display them on the users display. The area in a browser window where the user types out the URL is called as the address bar. This bar generally displays the URL of the current page. Web Pages are also accessed by clicking with a mouse on “hyperlinks”. This leads to display of URLs of Web Pages so accessed, in the address bar. These URLS are typically a barely comprehensible string of characters that do not make much sense to a normal user. These URLs are often cryptic, following very complex schemes and formats in their naming conventions.

For example, as soon as one accesses his/her mailbox through www.mail.yahoo.com, the following string of barely comprehensible characters is displayed:

http://us.f118.mail.yahoo.com/ym/login?.rand=aklg0qhpd81vs.

This does not make sense to most users. Instead it will be preferable to have a description such as “My Inbox” as soon as the URL is loaded

Also URLs cannot include space and the domain names in the URLs cannot include space or prohibited special characters except “hyphen” or “underscore”. This usage goes against the way the language is normally written. The same restrictions apply to email addresses too. The current technology also makes the use of long domain names and email addresses difficult due to the difficulty involved in remembering, comprehending and keying them in.

For example a company called John Smith Inc or an individual called John Smith, currently might have a web address reading

htttp://www.Johnsmith.com (John no space smith) or

http://www.John_Smith.com (John underscore smith) or

http://www.John-Smith.com. (John hyphen smith)

None of these alternatives resemble the way in which the name is naturally written. It is natural to type the address as www. John Smith.com or even just John Smith—the way the word is naturally written. But the current technology does not permit this to happen.

Looking at Email addresses, a company called John Smith Inc or an individual called John Smith might have an email address reading:

John_smith@Yahoo.com (read as John underscore smith@yahoo.com) or

John-smith@yahoo.com (read as John hyphen smith@yahoo.com) or

Johnsmith@yahoo.com. (read as John nospace smith@yahoo.com)

None of these alternatives resemble the way in which the name is naturally written. It is natural to type the address as

John Smith@yahoo.com the way the word is naturally written. But the current technology does not permit this to happen.

### SUMMARY OF THE INVENTION

Certain objects, advantages, and novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the claim.

To achieve the advantages and novel features, the present invention is generally directed to an apparatus and method for controlling the display of and for resolving special characters in URLs, URIs, email addresses and Web Pages.

Other objects and advantages of the present invention will become apparent from the following descriptions, taken in connection with the accompanying drawings, wherein, by way of illustration and example, an embodiment of the present invention is disclosed.

In the preferred embodiment, a machine and method for controlling the display of URLs and URIs and for resolving special characters in URLs, URIs, email addresses, Web Pages and in other areas where a name is to be used for accessing or processing information related to the World Wide Web comprises an input device such as a keyboard or mouse, an output device such as a display or printer, and a computer for receiving data from the input devices and for transmitting data to the output devices. The computer also stores program steps for program control and manipulates data in memory.

In accordance with one embodiment of the present invention a Web browser with the invented method and apparatus will display meaningful and useful information on the address bar and a user using such a Web browser will be able to respond to such meaningful and useful information that is displayed in the address bar and cause the response to be sent to a designated destination. The address bar supports multiple layers or channels. The user can personalize what information he receives through the address bar in what can be called “The Personal Information Channel”. This information may include but is not limited to display of personal information like Stock quotes, News, Weather, Auction bids, Event notifications, Pager messages, SMS messages through mobile devices, Beeper alerts etc., This information obviously will vary from user to user.

In accordance with another embodiment of the present invention, the Web browser with the invented method and apparatus will accept Email ID's or URL's, URI's with non-permitted special characters and convert them into the standard acceptable form. This converted form of the URL/URI/Email ID will be sent to the appropriate server and corresponding files are opened. This will ensure the confusion in remembering domain names is lessened. The user can type the name of the company or an individual exactly as he would write it. For example a company called Barnes and Noble can have a iste called barnesandnoble.com but the user needs to type Barnes and noble.com, exactly what he would write it as. Now the user need not worry if the correct URL is barnes_and_noble.com or barnesandnoble.com or barnes-and-noble.com or variations of these. The same method can be applied to Email ID's lessening confusion.

The enclosed drawings explain these methods in detail. The drawings constitute a part of this specification and include exemplary embodiments to the invention, which may be embodied in various forms.

### BRIEF DESCRIPTION OF THE DRAWINGS

All the enclosed drawings are self-explanatory and descriptions within the drawings make their meaning very clear.

FIG. 1 is a representation of USER EXPERIENCE for resolution of special characters in URLs and URIs

FIG. 2 is a representation of PROGRAM FLOW for resolution of special characters in URLs and URIs

FIG. 3 is a representation of PROGRAM WORKING for resolution of special characters in URLs and URIs

FIG. 4 is a representation of PROGRAM PACKAGING for resolution of special characters in URLs and URIs

FIG. 5 is a representation of USER EXPERIENCE for resolution of special characters in eMail IDs

FIG. 6 is a representation of PROGRAM FLOW for resolution of special characters in eMail IDs

FIG. 7 is a representation of PROGRAM WORKING for resolution of special characters in eMail IDs

FIG. 8 is a representation of PROGRAM PACKAGING for resolution of special characters in eMail IDs

FIG. 9 is a representation of USER EXPERIENCE for resolution of special characters in user names/Log-in IDs in Web Pages

FIG. 10 is a representation of PROGRAM FLOW for resolution of special characters in user names/Log-in IDs in Web Pages

FIG. 11 is a representation of PROGRAM WORKING for resolution of special characters in user names/Log-in IDs in Web Pages

FIG. 12 is a representation of PROGRAM PACKAGING for resolution of special characters in user names/Log-in IDs in Web Pages

FIG. 13 is a representation of USER EXPERIENCE for controlling the display of messages in the Address bar of a browser in any form

FIG. 14 is a representation of PROGRAM FLOW for controlling the display of messages in the Address bar of a browser in any form

FIG. 15 is a representation of PROGRAM WORKING for controlling the display of messages in the Address bar of a browser in any form

FIG. 16 is a representation of PROGRAM PACKAGING for controlling the display of messages in the Address bar of a browser in any form

The above figures and the following description are intended to exemplify exemplary embodiments of the present invention. It is to be understood that other embodiments may be utilized and structural and functional changes may be made without departing from the spirit and scope of the present invention

### DETAILED DESCRIPTION OF THE DRAWINGS

The present invention provides a method and apparatus for controlling the display of and for resolving special characters in URL's URI's and Email ID's. In an embodiment of the present invention, in conjunction with a current browser, such as Netscape.™. Or Internet Explorer.™., the display of what appears in the address bar is controllable. This method also makes possible for a user to enter non-permitted special characters like spaces. Alternatively, an embodiment of the present invention may be incorporated in a new browser. A more detailed description of the implementation of the present invention will subsequently be provided. Prior to that discussion, an environment in which the present invention may be implemented will be described in greater detail.

In the following description, numerous specific details are set forth to provide a thorough understanding of the present invention. However, it will be obvious to those skilled in the art that the present invention may be practiced without such specific details. In most diagrams too many details have not been given in order not to obscure the present invention in unnecessary detail. For the most part, details concerning mundane workings have been omitted inasmuch as such details are not necessary to obtain a complete understanding of the present invention and are within the skills of persons of ordinary skill in the relevant art.

Refer now to the drawings.

The drawings are split into four major heads.

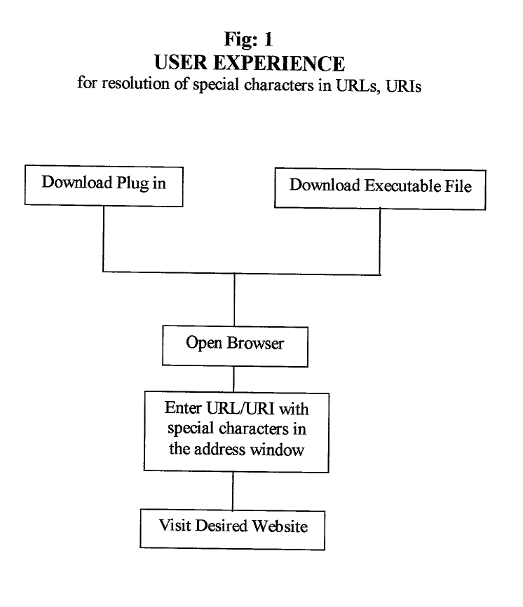

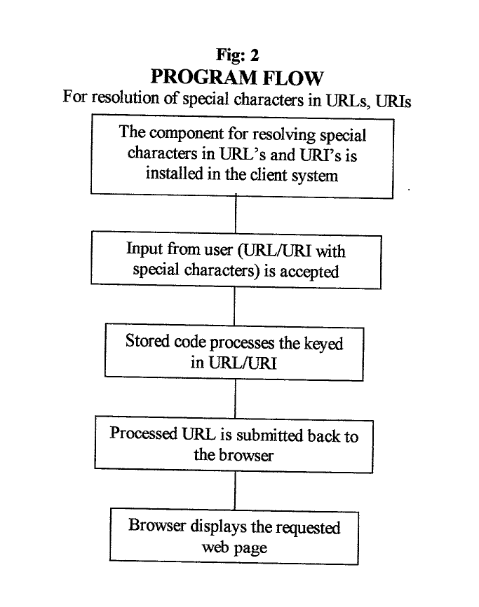

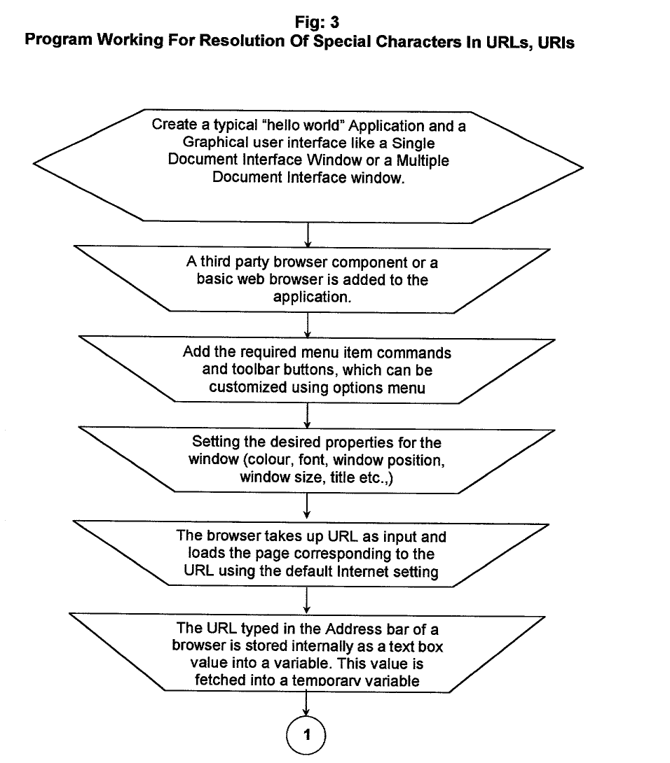

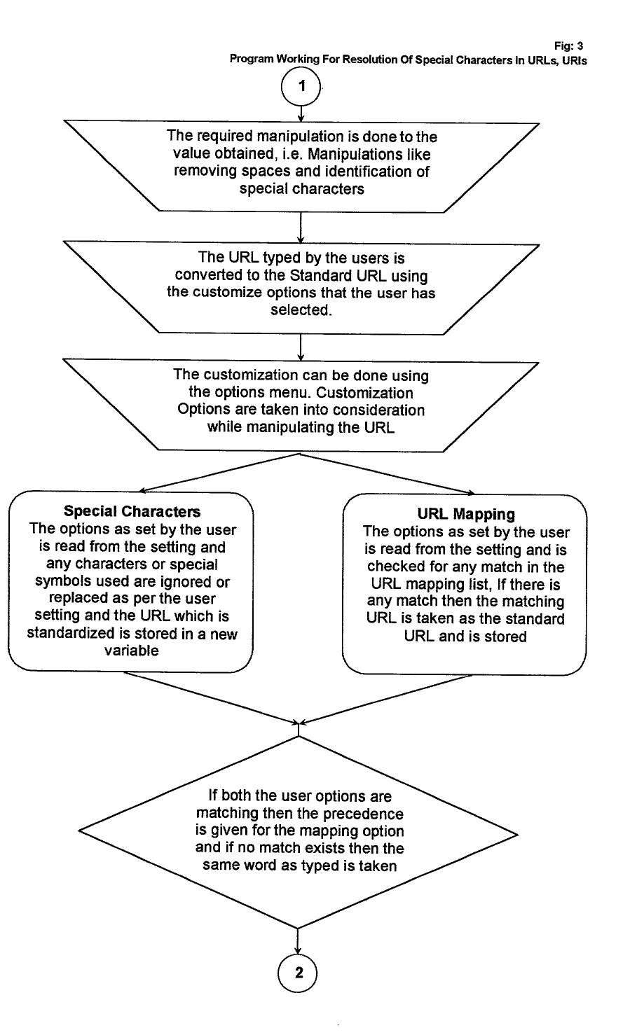

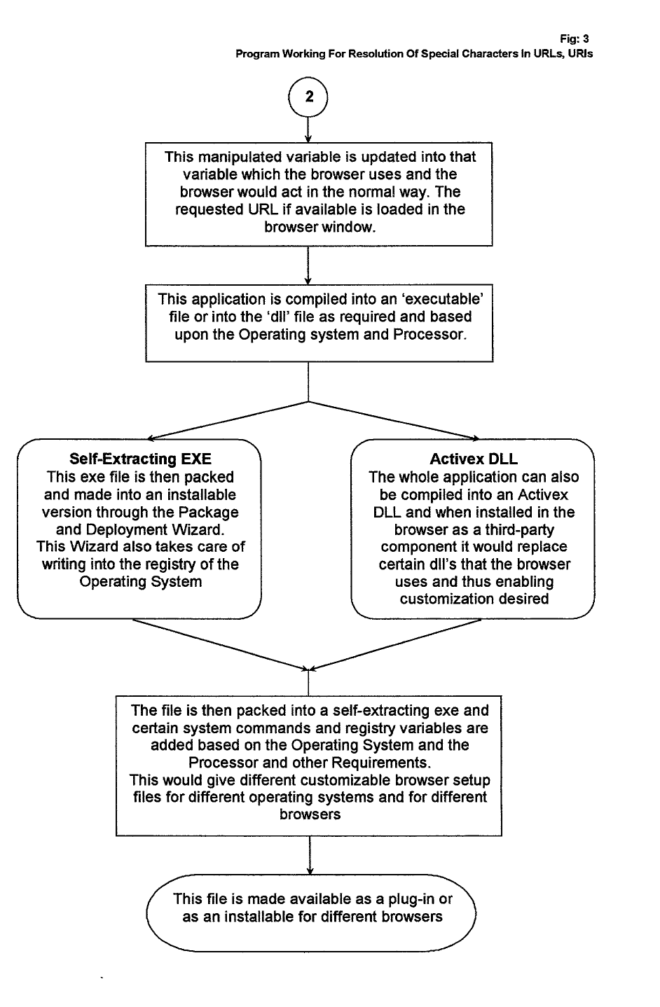

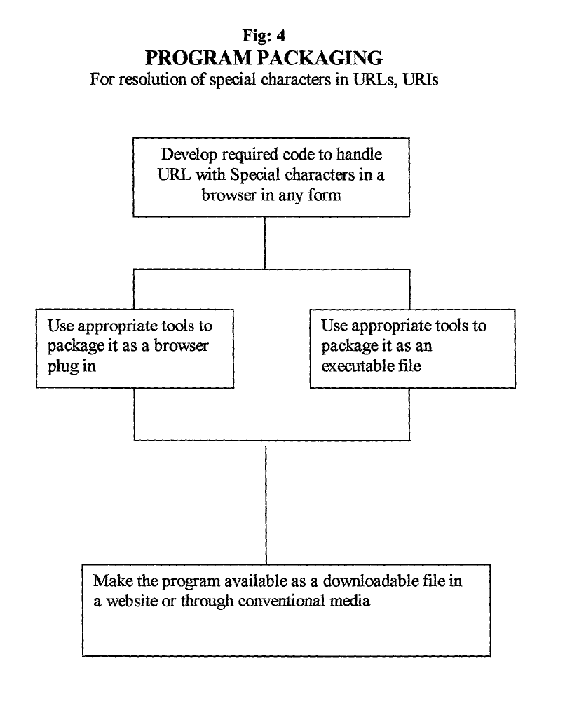

FIGS. 1-4 explain the resolution of special characters in URLs and URLs

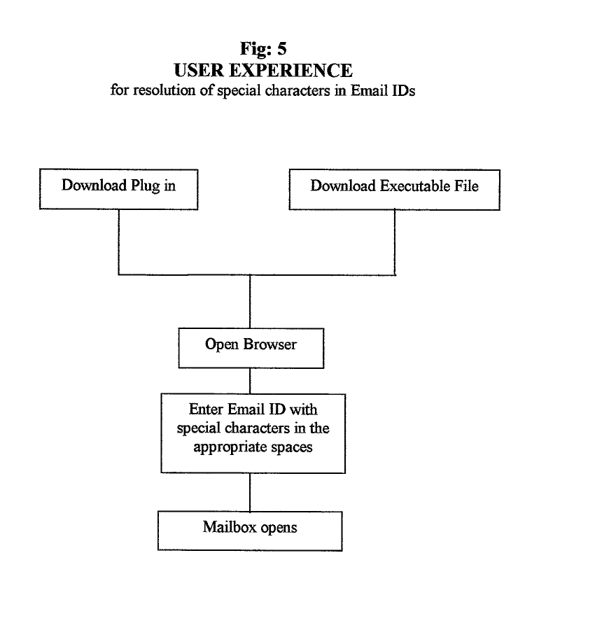

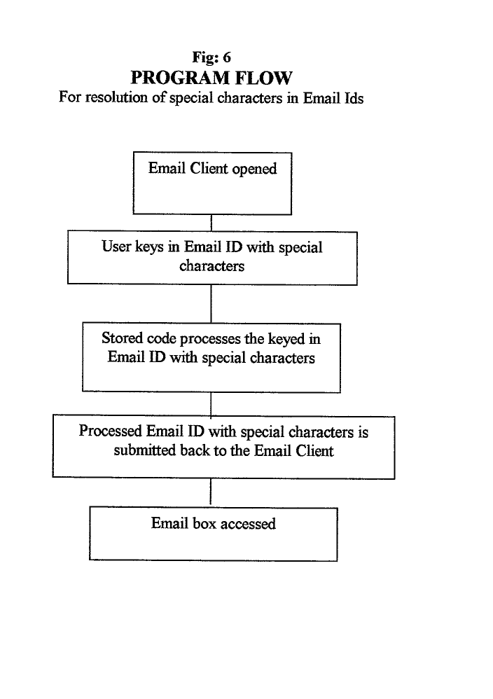

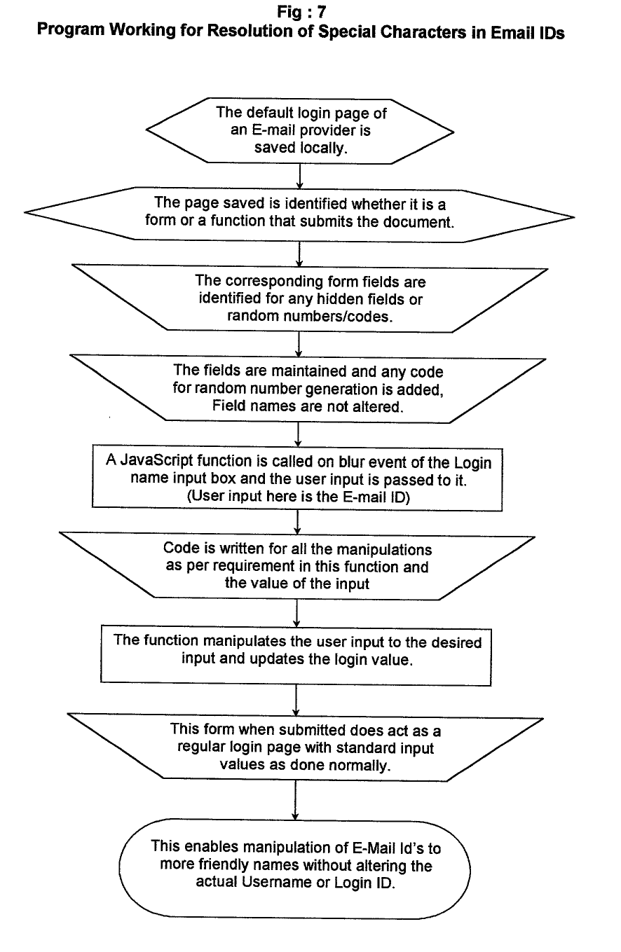

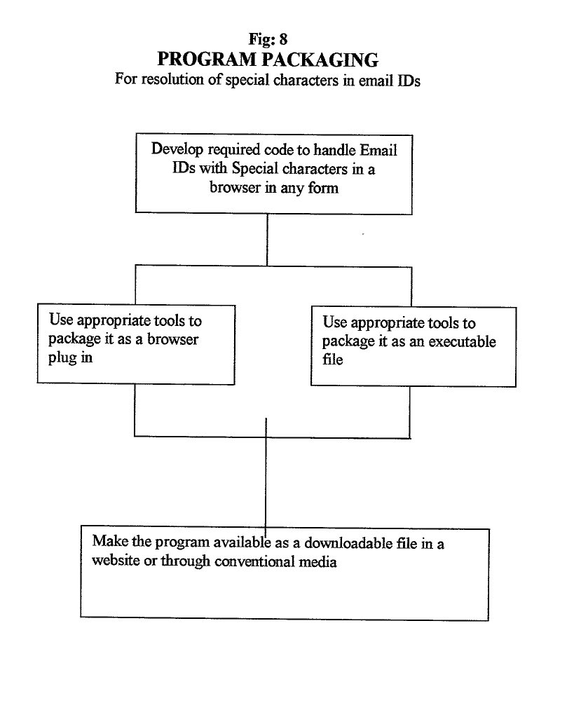

FIGS. 5-8 explain the resolution of special characters in email Ids

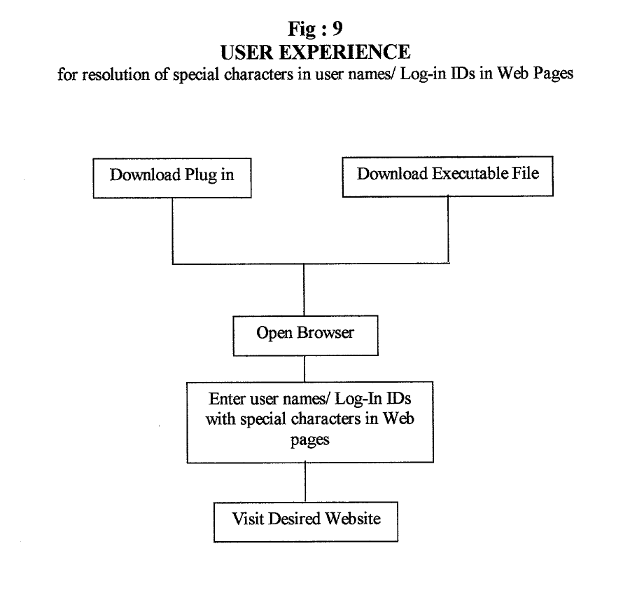

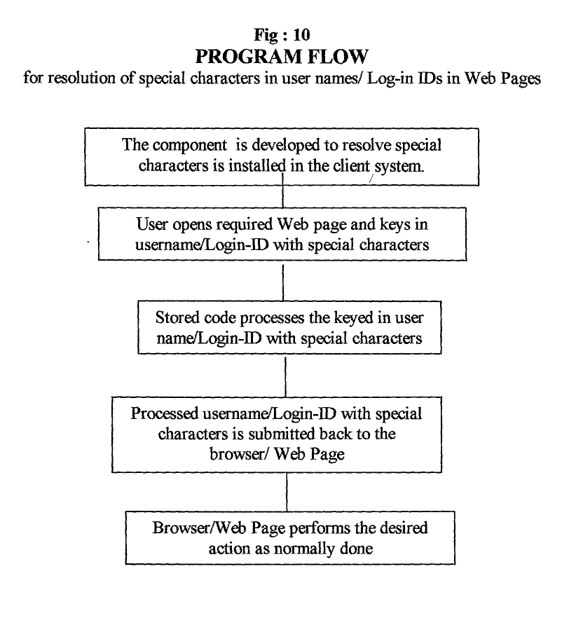

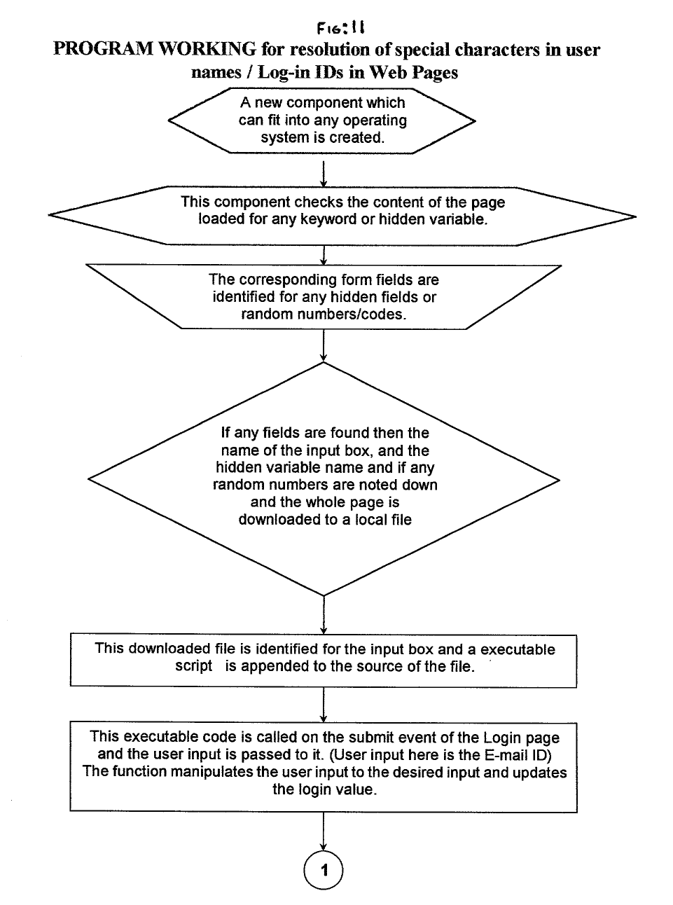

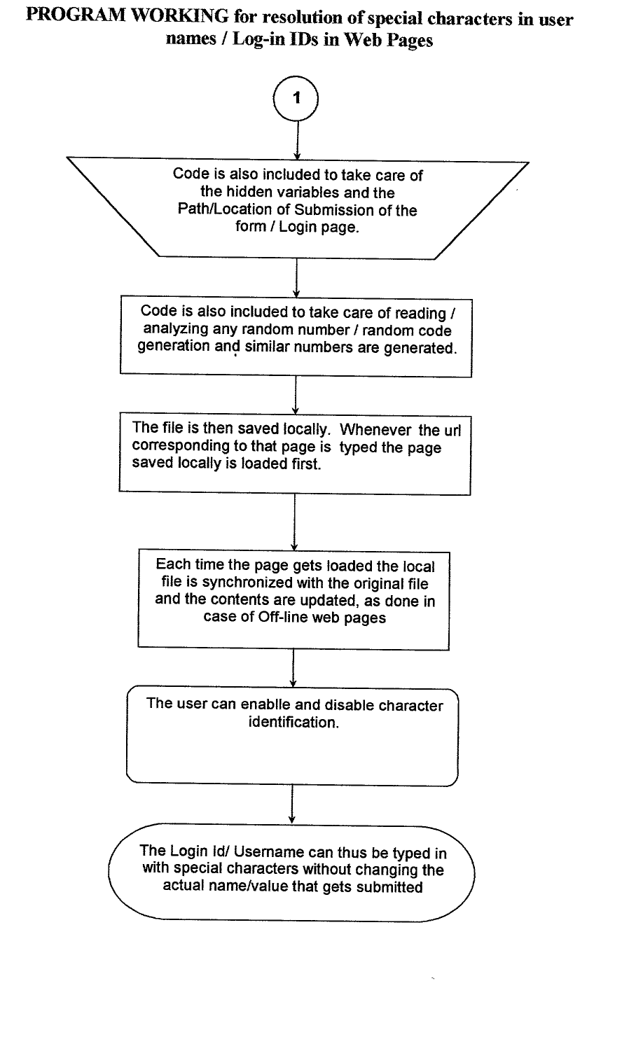

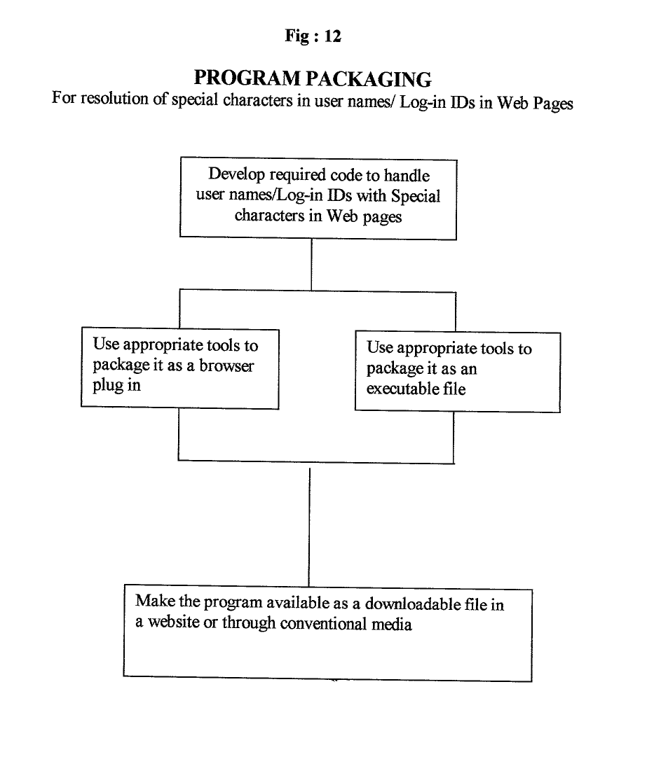

FIGS. 9-12 explain the resolution of special characters in user names/Log-in IDs in Web Pages

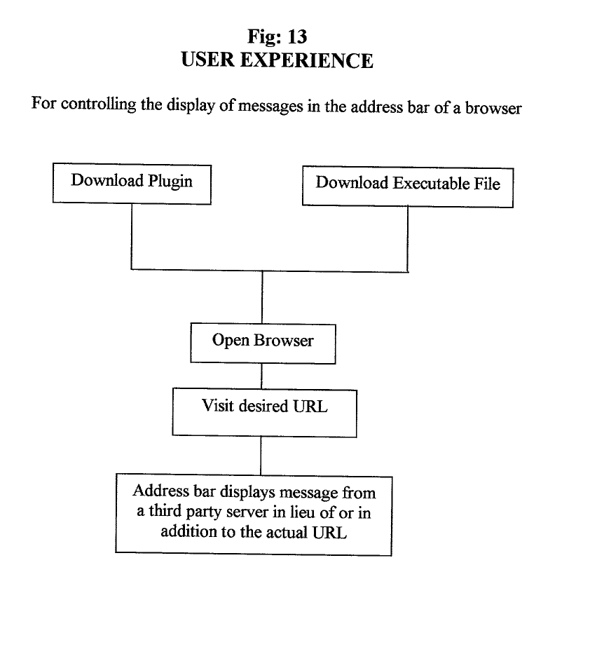

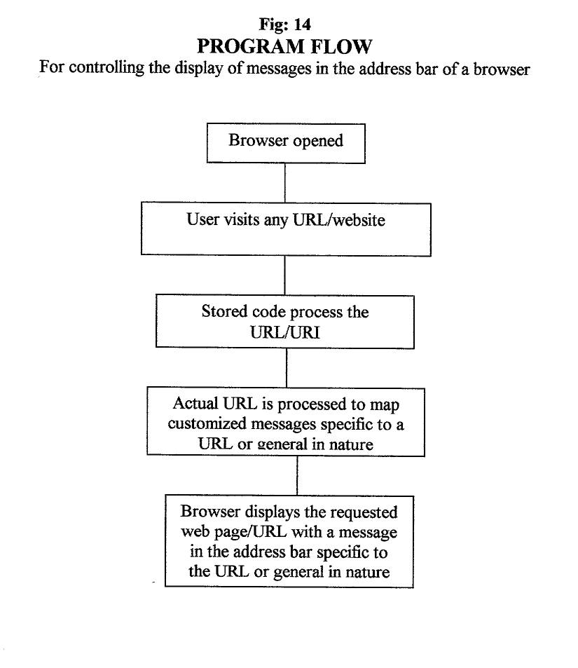

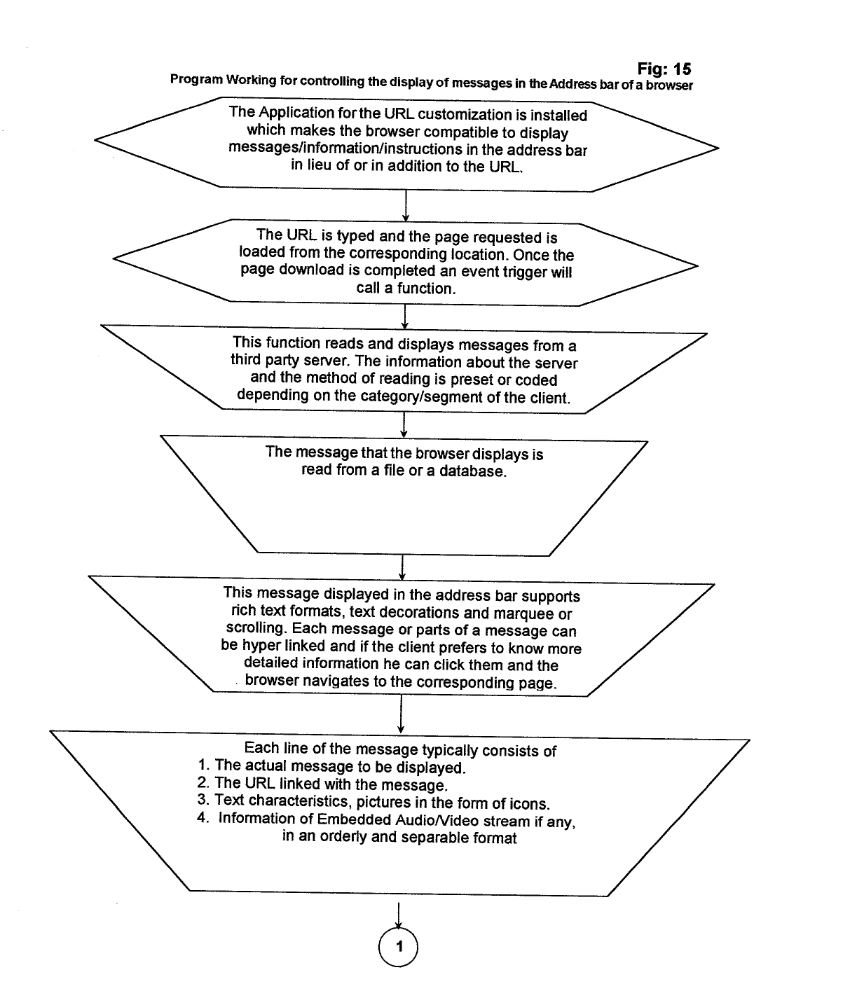

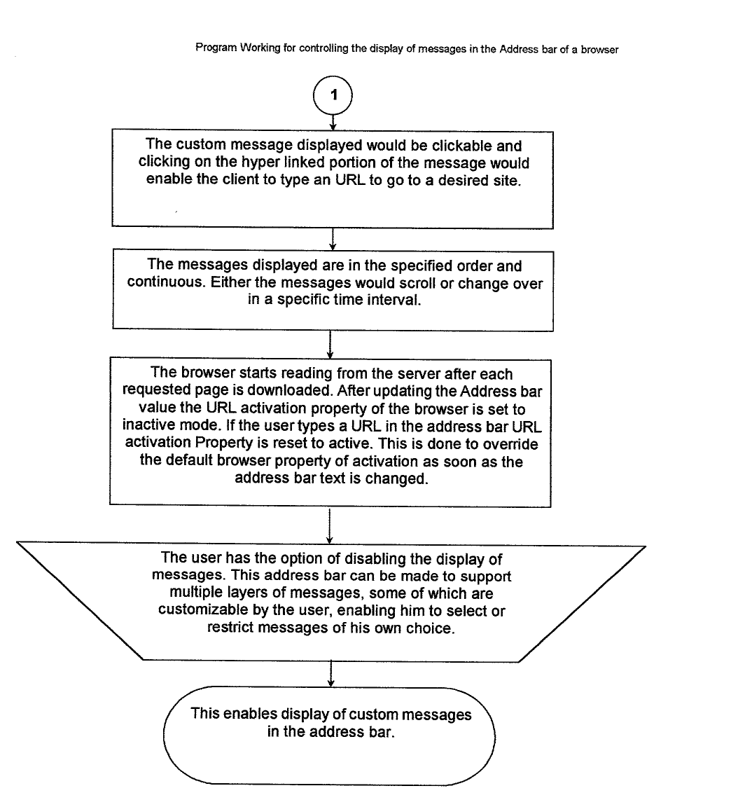

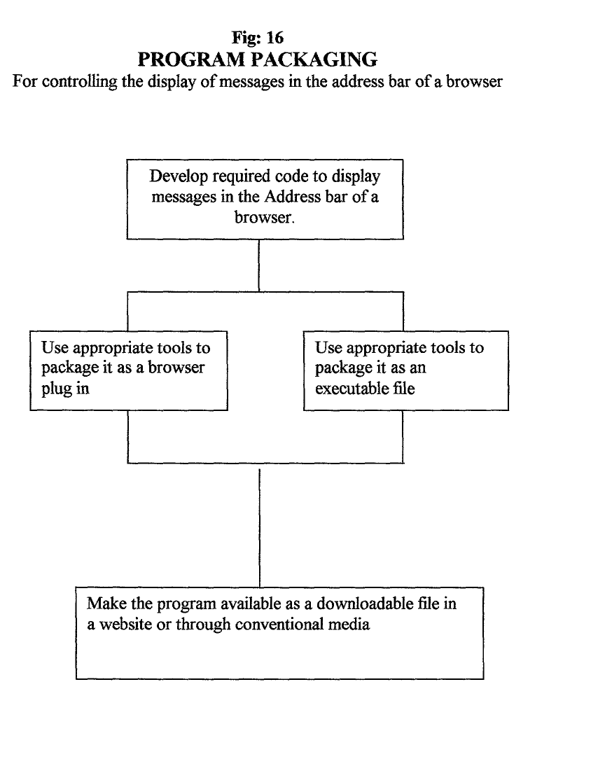

FIG. 13-16 explain controlling display of messages in the Address bar of a browser.

Each of these four major heads is split into four more heads

1. User Experience

2. Program Flow

3. Program Working

4. Program Packaging

User experience

This category lists what an user will see and experience as he uses the method claimed.

Program Flow

This category lists in sequence the basic logic followed to implement the method.

Program Working

This category lists in sequence the actual procedures followed to create the apparatus.

Program Packaging

This category lists how the final product is packaged and distributed to the user.

The diagrams are self-explanatory and additional comments needed to understand them are provided in the figures themselves.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is anticipated that the preferred embodiment of the present invention will be a commercial product sold under the trade name spazeIT.™. to be used with the following operating systems computer systems and web browsers.

Windows '95.™, Windows '98™, Windows 2000™ or later versions

Windows NT.™ or later versions

operating systems being run on an Intel.™. Pentium.™. processor or later processors

operating systems running on computer systems equivalent to Intel™ processors like those being manufactured by Cyrix, AMD and others or later processors

operating systems like UNIX, LINUX, SOLARIS and equivalent operating systems brought out by other software developers and Hardware manufacturers

Web browsers like Internet Explorer, Netscape Navigator, Mozilla, Mosaic and others and equivalent modifications to these particular operating systems and processors would be evident and not be beyond the present invention.

Accordingly, the trade name will be referred to throughout this detailed description as the entire software program, the machine for implementing the program and the specific portion of the program and machine dedicated to controlling the display of and for resolving special characters in URLs, URIs, Web Pages and Email addresses and in other areas where a name (of an individual or an organization) is to be used for accessing or processing information related to the internet and world wide web. The context of the term spazeIT™. will make obvious the intended reference.

The computer is an apparatus for carrying out the preferred embodiment of the invention. A computer of the traditional type including ROM, RAM, a processor, etc. is operatively connected by wires to a display, keyboard, mouse and printer, though a variety of connections means and input and output devices may be substituted without departing from the invention. The processor operates to control the program within the computer, and receive and store data from the input devices and transmit data to the output devices. Notebook computers of similar configuration (ROM, RAM, processor, etc.), can be used as well. In addition, other devices that are being or may be connected to the Internet or World Wide Web like wireless devices including but not limited to mobile phones, pagers and similar communication devices, microwave ovens, washing machines, refrigerators, Televisions, Air conditioning equipments, Dish washing machines, clothes and other apparel pressing machines and other household appliances, cars, vans, buses, lorries, trucks, trains, aero planes and other vehicles that may connect to the Internet and World Wide Web.

Upon initiating the program, which may take place in a variety of conventional ways and is not part of the present invention, the computer causes to display the desired information in the address window and to accept the typing in of special characters as part or entirely of URIs and URLs, Web Pages, Email addresses and in other areas where a name (of an individual or an organization or any entity) is to be used for accessing or processing information related to the World Wide Web, and converts it to a form which will cause it to fetch information from or send information to the appropriate URLs, URIs, Web Pages, Email addresses and Email messages and in other areas where a name (of an individual or an organization or any entity) is to be used for accessing or processing information related to the World Wide Web. Additionally special or general messages may be displayed in the address field area of a browser where typically the URL or URI is displayed.

In the preferred commercial embodiment of the package this invention will also have a button added to the browser that if selected by positioning a cursor over the button and clicking with a mouse button, scratch pad button or other appropriate interface device or selecting and depressing the Enter key on the keyboard which then will display information about this invention and its usage.

What is claimed is:

1. A method of controlling what appears in the display of the address bar of a Web browser, the method comprising the steps of:
responsive to opening the web browser in the client system, loading stored information from a server onto the client system, the said information then being displayed in the address bar.

2. The method of claim 1, further including the step of loading stored information responsive to the entry of a URL by the client system, the said information being displayed in the address bar in addition to or in lieu of the URL entered.

3. The method of claim 1, further including the step of displaying information in a web browser's address bar or its equivalent as may be used in a hand held device or a palmtop device or a cellular phone or similar such devices.

4. The method of claim1, further including the step of the information carrying an audio file along with it, which can be played by the client.

5. The method of claim1, further including the step of the said information being sent by any company permitted to do so.

6. The method of claim 1 further including the step of the information made to scroll as in a marquee across the address bar.

7. The method of claim 1 further including the step of the information displayed in the form of icons on the address bar.

8. The method of claim 5 further including the step of the information being sent from multiple servers and locations.

9. The method of claim 1, further including the step of the client being able to interact with the information on the address bar and cause a response to be sent back to the original sender or a designated party.

10. The method of claim 9, further including the claim of the said client interaction with the information happening at the client system by clicking on the information displayed in the address bar with a mouse or any other suitable device.

11. The method of claim 5, further including the step of the information being sent to all users in a typical “broadcast mode” or to specific users grouped by desired characteristics

12. The method of claim 5, further including the step of messages from multiple servers/locations being displayed on multiple layers in the address bar in a client system where the client has the choice of choosing the layer he wishes to see.

13. The method of claim 5 further including the step where the information sent is personalized to the client and is different for different clients.

14. The method of claim 1 further including the step of user being able to input another URL by clicking on the address bar.

15. The method of claim 1, further including the step of a user being able to “turn off” this facility

16. A method for resolving non-permitted special characters (like space) in Email addresses, URL's, URI's comprising the steps of,
responsive to the entry of a URL/Email ID with a non-permitted special character,
converting the said URL/Email ID into a permitted form, thereby connecting the client system to the desired server.

17. The method of claim 16, further including the step of removing non-permitted special characters from the client system input thereby converting them into the permitted form.

18. The method of claim 16, further including the step of the processed URL being submitted to a server to access the appropriate information
